(19) United States
(12) Patent Application Publication
(10) Pub. No.: US 2024/0161177 A1
(43) Pub. Date: May 16, 2024

(54) Digital Plot Twist Consensus

(71) Applicant: Justin Charles Clark, San Antonio, TX (US)

(72) Inventor: Justin Charles Clark, San Antonio, TX (US)

(21) Appl. No.: 18/510,140

(22) Filed: Nov. 15, 2023

Related U.S. Application Data
(60) Provisional application No. 63/384,019, filed on Nov. 16, 2022.

(51) Int. Cl. G06Q 30/0601; G06Q 30/08

(52) U.S. Cl. CPC G06Q 30/0641; G06Q 30/08; G06Q 2220/10

(57) ABSTRACT

A computer-implemented method of creating and changing one or more non-fungible tokens (NFTs) is disclosed. The method comprising steps of setting a time frame for NFT creation after receiving the time frame from a user; creating one or more storylines about the one or more NFTs within the time frame; associating the storylines with the one or more NFTs; receiving approval information from the user; displaying the one or more NFTs for public purchase, wherein the one or more NFTs includes one or more plots; receiving purchase information from a buyer; receiving bidding information from one or more fans; determining a purchased NFT that received the highest number of fans; retrieving at least one coded manuscript; and changing the at least coded manuscript according to the purchased NFT that received the highest number of fans.

### FIELD OF THE INVENTION

The present invention relates generally to an application. More specifically, the present invention is the art of providing a fixed service through an open-source marketplace.

### BACKGROUND OF THE INVENTION

The present invention is an application that encompasses the art of providing a fixed service through an open-source marketplace with the means of amending or altering a written script, document, film, or play from the acquisition of non-fungible token (NFT's).

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a fixed service through an open-source marketplace with the means of amending or altering a written script, document, film, or play from the acquisition of non-fungible token (NFT's).

The fixed service of the present invention can be a computer-implemented method of creating and changing one or more non-fungible tokens (NFTs). The method comprises steps of setting a time frame for NFT creation after receiving the time frame from a user; creating one or more storylines about the one or more NFTs within the time frame; associating the storylines with the one or more NFTs; receiving approval information from the user; displaying the one or more NFTs for public purchase, wherein the one or more NFTs includes one or more plots; receiving purchase information from a buyer; receiving bidding information from one or more fans; determining a purchased NFT that received the highest number of fans; retrieving at least one coded manuscript; and changing the at least coded manuscript according to the purchased NFT that received the highest number of fans.

In one embodiment, the purchased NFT includes the one or more NFTs.

In some embodiments, the method further includes a step of receiving, using a communication device, one or more exchanged NFTs for further change of the coded manuscript.

### BRIEF DESCRIPTION OF THE DRAWINGS

FIG. 1 is an illustration of an online platform consistent with various embodiments of the present disclosure.

FIG. 2 is a block diagram of a system including a communication, processing storage device of the present invention.

FIG. 3 is a flow chart showing one embodiments of the method of the present disclosure.

FIG. 4 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for providing a fixed service through an open-source marketplace with the means of amending or altering a written script, document, film, or play from the acquisition of non-fungible token (NFT's), embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a creator, fans thereof. Further, the user as defined herein may refer to a human, an animal, or an artificially intelligent being in any state of existence, unless stated otherwise, elsewhere in the present disclosure.

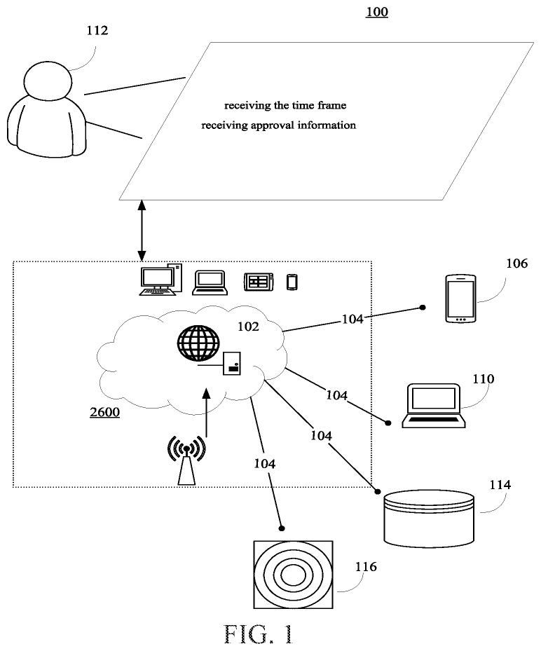

FIG. 1 is an illustration of an online platform 100 consistent with various embodiments of the present disclosure. By way of non-limiting example, the online platform 100 facilitating the method of creating and changing one or more non-fungible tokens (NFTs) may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, the databases 114 may be associated with government agencies. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties including buyers and fans, may access online platform 100 through a web based software application or browser. The web based software application may be embodied as, for example, but not be limited to, a website, a web application, a desktop application, and a mobile application compatible with a computing device 2600.

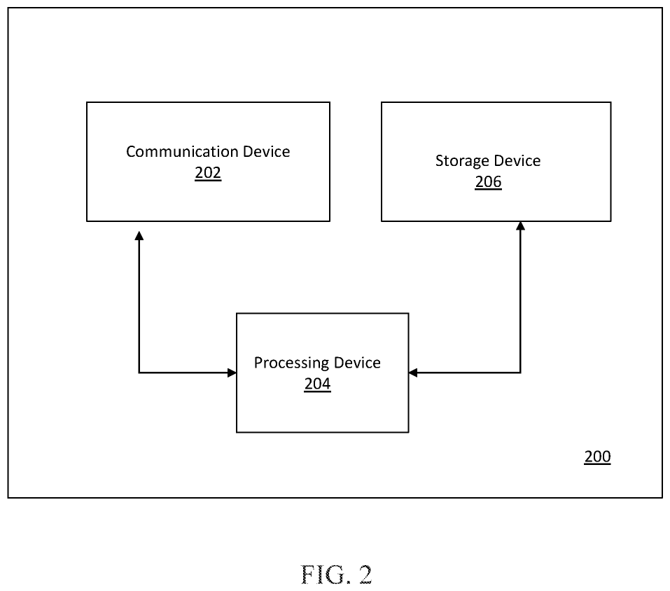

FIG. 2 is a block diagram of a system 200 for facilitating the method of creating and changing one or more non-fungible tokens (NFTs) with some embodiments. Accordingly, the system 200 may include a communication device 202, a processing device 204, and a storage device 206.

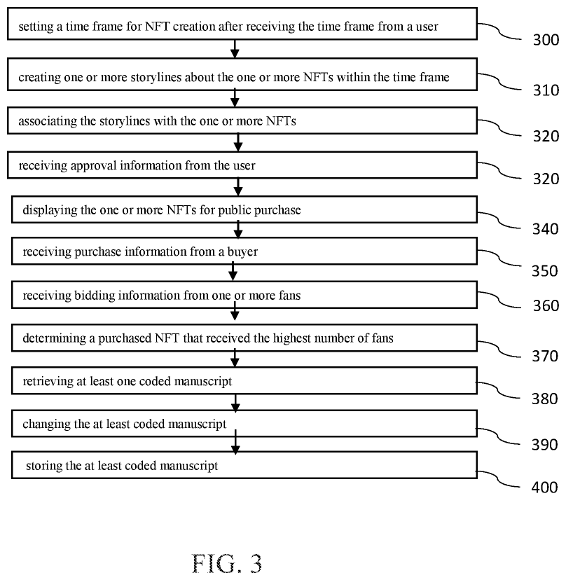

Further, the communication device 202 may be configured for various steps shown in FIG. 3.

Further, the processing device 204 may be communicatively coupled with the communication device 202. Further, the processing device 204 may be configured for various steps shown in FIG. 3.

Further, the storage device 206 may be communicatively coupled with the processing device 204. Further, the storage device 206 may be configured for various steps shown in FIG. 3.

The present invention, hereinafter referred to as “Digital Plot Twist Consensus,” is an application designed to provide a fixed service through an open-source marketplace with the means of amending or altering a written script, document, film, or play from the acquisition of non-fungible token (NFTs).

An NFT is a non-interchangeable unit of data stored on a digital ledger, typically a blockchain. It uses cryptographic techniques to provide a digital certificate of authenticity. NFTs can be used to represent digital items such as photos, videos, audio, etc.

The present invention, (Just Influence NFT system) is designed to transform NFTs into a consensus operating system, enabling peer-to-peer and business-to-peer transactions for the alteration of traditional movie scripts and literary works. This innovative system disrupts conventional processes by attaching written information within the digital signature of NFTs, allowing for the creation of new scripts or literary work segments and unlocking the consensus for amendments or removals.

In one embodiment, the present invention may include following formula:

JI=(NFT×BC)+(C+U)−L+(V×W)
JI represents the “Just Influence” system. NFT stands for the utilization and impact of Non-Fungible Tokens within the system.
BC symbolizes Blockchain Technology and its integration within the “Just Influence” framework.
C represents community involvement and engagement
U stands for User Experience and interface design
L signifies Legal Compliance and adherence to intellectual property rights
V represents the Voting Mechanism, enabling NFT holders to propose and vote on storyline changes or character developments
W symbolizes Writer/Creator Collaboration, incorporating winning NFTs into movie scripts and literary art, fostering collaboration and new revenue streams.

The “Just Influence” NFT system is designed to facilitate the alteration and creation of movie scripts and literary works through the utilization of NFTs.

In one embodiment, within the scope of the present invention, the NFT creator 15 may operate as follows: An establisher or establishment may tokenize movie, or literary intellectual property through NFTs for public or private sale. The present invention may include a plurality of Master NFT Creator(s) of “Just Influence style” NFT which tokenizes intellectual property such as cinema or literary related content for the minting process that represents different story elements, characters, or plot twists. Each NFT should have a unique attribute or contribution to the storyline.

The NFT minting process is unique for several variables. Primarily, the ecosystem is engineered to feature artwork that is asymmetrical to specific characters, landmarks, and items within a fictitious world written and created for viewing entertainment by a master creator.

In one embodiment, the master creator may embed written, displayed, or audio information within the digital signature of the NFT relating to the subject matter of characters, landmarks, and items within a fictitious world. The embedded digital script within the NFT may contain information added by master NFT creator that function as a precursor to grant access to operating command menu relating to the subject matter of characters, landmarks, and items within a fictitious world under the contingency of ownership distribution.

In some embodiments, the present invention may include a process to develop smart contracts on a blockchain platform (e.g., Ethereum) to manage the NFTs. These contracts can outline the rules for how NFT holders can influence the story. This is established from the origin creation process prior to miming and is executed in the following manner:
1.) The master NFT creator (original maker) writes information to be approved, or disapproved by community members after a set time frame of minting publication. For example, “The main Character of a storyline is running away from zombies in a movie. He runs by Johnny AVE mid-scene. Before Johnny AVE was a street, it was A Just Influence NFT for purchase for closer Fandom appreciation.”
2.) Community members exercise their rights to collect NFT once NFT is Up-listed on an exchange for purchase.
A.) A fan named Johnny wish to purchase the NFT that promises to show his name within the big screens of a movie.

Each NFT owner should have a say in the story's outcome based on the NFT they hold. This utility is made whole when: The master creator fulfills their obligation to change the plot per consensus of the selected Just Influence NFT. By showcasing “Johnny AVE” within a movie scene, the obligation is complete.

In some embodiments, the present invention, NFTs to be implemented can be used :like a voting mechanism, this gives NFT owners the ability to propose and vote on storyline changes or character developments. This can be done through a decentralized application (DApp). In such embodiments, the present invention provides an opportunity for other competing fans to bid for the same NFTs or NFTs that counteract.

The present invention, Just Influence NFT, changes the dynamic of how writers, directors, and creators collaborate by incorporating the winning NFTs in their movie script and literary art.

The utility derives from the establishment of providing a servitude probability outcome from the acquisition of an artist/developer's sovereign or earmarked non-fungible Tokens (NFTs) assigned with the intent to transfigure and disrupt a piece of ecosystem of a designated literature, art, or film project.

The exchange of service is complete when the digital written script inside the code of the purchased designated sovereign or earmarked Non-fungible Token (NFT) is reflected within the creators fulfilled alternative outcome and pivotal consequences displayed in the designated art for viewers, watchers, and supporters' entertainment from the adjacent outcome.

The shift occurrence caused by NFT purchase amendment contributes to the art and nature in which an open-source consensus action is measured on an open-source ecosystem within fixed or timed auction assigned for public or private whitelisted clients Custodianship.

“Plot Twist” is the art of providing a fixed service through an open-source marketplace with the means of amending or altering a written script, document, film, or play from the Acquisition of Non-fungible Token (NFTs).

The utility derives from the establishment of providing a servitude probability outcome from the acquisition of an artist/developer's sovereign earmarked Non-fungible Tokens (NFTs) assigned with the intent to transfigure its designated task for subjects of literature, art, and films.

The exchange of service is complete when the digital promissory note included inside the code of the purchased designated sovereign Non-fungible Token (NFT) is fulfilled thus creating an alternative outcome and pivotal consequences of displayed art for viewers, watchers, and supporters' entertainment from the adjacent outcome. The occurrence of this amending application contributes to the art and nature in which an open-source consensus act is measured on an open-source network within a fostering fixed or timed auction ecosystem designated for public or private whitelisted clients Custodianship.

In preferred embodiment, as shown in FIG. 3, the present invention provides a computer-implemented method of creating and changing one or more non-fungible tokens (NFTs), the method comprising: setting a time frame for NFT creation, using a communication device, after receiving the time frame from a user at 300; creating, using a processing device, one or more storylines about the one or more NFTs within the time frame at 310; associating, using a processing device, the storylines with the one or more NFTs at 320; receiving, using a communication device, approval information from the user at 330; displaying, using a processing device, the one or more NFTs for public purchase, wherein the one or more NFTs includes one or more plots at 340; receiving, using a communication device, purchase information from a buyer at 350;
receiving, using a communication device, bidding information from one or more fans at 360; determining, using a processing device, a purchased NFT that received the highest number of fans at 370; retrieving, using a storage device, at least one coded manuscript at 380; changing, using a processing device, the at least coded manuscript according to the purchased NFT that received the highest number of fans at 390; and
storing, using a storage device, the at least coded manuscript after changing the at least coded manuscript according to the purchased NFT that received the highest number of fans at 400.

In some embodiments, the purchased NFT may include a digital promissory note.

In some embodiments, the one or more NFTs may include photos, videos, audio clips.

The purchased NFT may include the one or more NFTs that are created and in some embodiments, the method may further include a step of receiving, using a communication device, one or more exchanged NFTs for further change of the coded manuscript.

In some other embodiments, the purchased NFT purchased by buyers may include one or more exchanged NFTs exchanged by buyers.

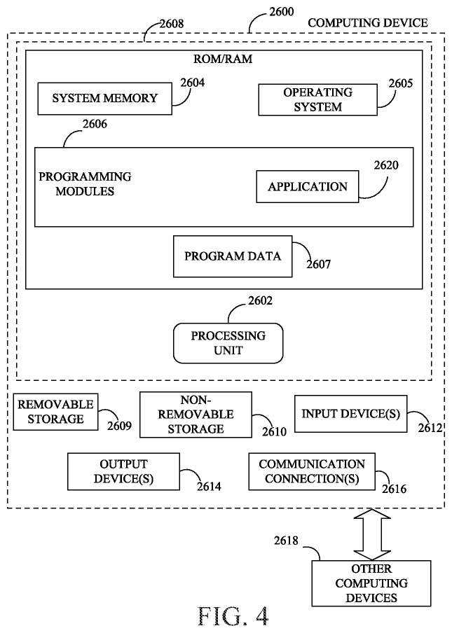

With reference to FIG. 4, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g. random-access memory (RAM)), non-volatile (e.g. read-only memory (ROM)), flash memory, or any combination. System memory 2604 may include operating system 2605, one or more programming modules 2606, and may include a program data 2607. Operating system 2605, for example, may be suitable for controlling computing device 2600's operation. In one embodiment, programming modules 2606 may include image-processing module, machine learning module, etc. Furthermore, embodiments of the disclosure may be practiced in conjunction with a graphics library, other operating systems, or any other application program and is not limited to any particular application or system. This basic configuration is illustrated in FIG. 4 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 4 by a removable storage 2609 and a non-removable storage 2610. Computer storage media may include volatile and non-volatile, removable and non-removable media implemented in any method or technology for storage of information, such as computer-readable instructions, data structures, program modules, or other data. System memory 2604, removable storage 2609, and non-removable storage 2610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, a location sensor, a camera, a biometric sensor, etc. Output device(s) 2614 such as a display, speakers, a printer, etc. may also be included. The aforementioned devices are examples and others may be used.

Computing device 2600 may also contain a communication connection 2616 that may allow device 2600 to communicate with other computing devices 2618, such as over a network in a distributed computing environment, for example, an intranet or the Internet. Communication connection 2616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2604, including operating system 2605. While executing on processing unit 2602, programming modules 2606 may perform processes including, for example, one or more stages of methods, algorithms, systems, applications, servers, databases as described above. The aforementioned process is an example, and processing unit 2602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A computer-implemented method of creating and changing one or more non-fungible tokens (NFTs), the method comprising:
setting a time frame for NFT creation, using a communication device, after receiving the time frame from a user;
creating, using a processing device, one or more storylines about the one or more NFTs within the time frame;
associating, using a processing device, the storylines with the one or more NFTs;
receiving, using a communication device, approval information from the user;
displaying, using a processing device, the one or more NFTs for public purchase, wherein the one or more NFTs includes one or more plots;
receiving, using a communication device, purchase information from a buyer;
receiving, using a communication device, bidding information from one or more fans;
determining, using a processing device, a purchased NFT that received the highest number of fans;
retrieving, using a storage device, at least one coded manuscript;
changing, using a processing device, the at least coded manuscript according to the purchased NFT that received the highest number of fans; and
storing, using a storage device, the at least coded manuscript after changing the at least coded manuscript according to the purchased NFT that received the highest number of fans.

2. The method as claimed in claim 1, wherein the purchased NFT includes a digital promissory note.

3. The method as claimed in claim 1, wherein the one or more NFTs include one or more photos.

4. The method as claimed in claim 1, wherein the one or more NFTs include one or more videos.

5. The method as claimed in claim 1, wherein the one or more NFTs include one or more audio clips.

6. The method as claimed in claim 2, wherein the purchased NFT includes the one or more NFTs.

7. The method as claimed in claim 1, further includes a step of receiving, using a communication device, one or more exchanged NFTs for further change of the coded manuscript.

8. The method as claimed in claim 7, wherein the purchased NFT includes the one or more exchanged NFTs.

9. A computer-implemented method of creating and changing one or more non-fungible tokens (NFTs), the method comprising:
setting a time frame for NFT creation, using a communication device, after receiving the time frame from a user;
creating, using a processing device, one or more storylines about the one or more NFTs within the time frame;
associating, using a processing device, the storylines with the one or more NFTs;
receiving, using a communication device, approval information from the user;
displaying, using a processing device, the one or more NFTs for public purchase, wherein the one or more NFTs includes one or more plots;
receiving, using a communication device, purchase information from a buyer;
receiving, using a communication device, bidding information from one or more fans;
determining, using a processing device, a NFT that received the highest number of fans;
retrieving, using a storage device, at least one coded manuscript;
changing, using a processing device, the coded manuscript according to the NFT that received the highest number of fans;
receiving, using a communication device, one or more exchanged NFTs for further change of the coded manuscript; and
storing, using a storage device, the at least coded manuscript after changing the at least coded manuscript according to the purchased NFT that received the highest number of fans.

10. The method as claimed in claim 4, wherein the purchased NFT includes a digital promissory note.

11. The method as claimed in claim 1, wherein the purchased NFT includes a digital promissory note.

12. The method as claimed in claim 1, wherein the one or more NFTs include one or more photos.

13. The method as claimed in claim 1, wherein the one or more NFTs include one or more videos.

14. The method as claimed in claim 1, wherein the one or more NFTs include one or more audio clips.

15. The method as claimed in claim 9, wherein the purchased NFT includes the one or more NFTs.

16. A computer-implemented method of creating and changing one or more non-fungible tokens (NFTs), the method comprising:
setting a time frame for NFT creation, using a communication device, after receiving the time frame from a user;
creating, using a processing device, one or more storylines about the one or more NFTs within the time frame;
associating, using a processing device, the storylines with the one or more NFTs;
receiving, using a communication device, approval information from the user;
displaying, using a processing device, the one or more NFTs for public purchase, wherein the one or more NFTs includes one or more plots;
receiving, using a communication device, purchase information from a buyer, wherein the purchased NFT includes the one or more NFTs;
receiving, using a communication device, bidding information from one or more fans;
determining, using a processing device, a NFT that received the highest number of fans;
retrieving, using a storage device, at least one coded manuscript;
changing, using a processing device, the coded manuscript according to the NFT that received the highest number of fans;
receiving, using a communication device, one or more exchanged NFTs for further change of the coded manuscript; and
storing, using a storage device, the at least coded manuscript after changing the at least coded manuscript according to the purchased NFT that received the highest number of fans.

17. The method as claimed in claim 15, wherein the purchased NFT includes a digital promissory note.

18. The method as claimed in claim 16, wherein the one or more NFTs include one or more photos.

19. The method as claimed in claim 16, wherein the one or more NFTs include one or more videos.

20. The method as claimed in claim 16, wherein the one or more NFTs include one or more audio clips.
